(19) United States
(12) Patent Application Publication
(10) Pub. No.: US 2022/0063678 A1
(43) Pub. Date: Mar. 3, 2022

(54) MODE MANAGEMENT FOR AUTONOMOUS VEHICLES

(71) Applicant: WAYMO LLC, Mountain View, CA (US)

(72) Inventors: Nolan McPeek-Bechtold, Belmont, CA (US); Daniel Egnor, San Mateo, CA (US); Leonid Vaynberg, Redwood City, CA (US); Ryan Cash, Sunnyvale, CA (US)

(21) Appl. No.: 17/004,790

(22) Filed: Aug. 27, 2020

(51) Int. Cl. B60W 60/00; B60W 50/08

(52) U.S. Cl. CPC B60W 60/0057; B60W 60/0015; B60W 2050/0096; B60W 50/087; B60W 50/082

(57) ABSTRACT

Aspects of the disclosure relate to controlling transitions between driving modes of an autonomous vehicle. The vehicle may have a first mode that is a manual driving mode, a second mode that is an autonomous driving mode where a driver is expected to be present to take control, and a third mode where a driver is not expected to be present to take control. While operating in the second mode, a request to transition to the first mode may be received. In response, the vehicle may transition to the first mode. After transitioning to the first driving mode, the vehicle may be prevented from transitioning the first mode to the second mode or the third mode until a predetermined duration has passed even when input is received at one or more of a steering wheel, brake pedal, or accelerator during the predetermined period.

### BACKGROUND

Some vehicles may operate in various modes which provide different levels of control to a driver. For instance, typical vehicles may operate in manual driving modes, where a human operator or driver controls acceleration, deceleration, and steering of the vehicle as well as semi-autonomous driving mode, such as cruise control, where a computer of the vehicle controls acceleration and deceleration while a driver controls steering, etc. In some instances, these vehicles may also operate in autonomous driving modes where the computer of the vehicle controls all of braking, all of the acceleration, deceleration and steering of the vehicle without continuous input from a driver or passenger. In the autonomous driving mode, the passenger may provide some initial input, such as a destination location, and the vehicle maneuvers itself to that destination.

### BRIEF SUMMARY

Aspects of the disclosure provide a method of controlling transitions between driving modes of an autonomous vehicle. The vehicle includes a first driving mode that is a manual driving mode, a second driving mode that is an autonomous driving mode where a driver is expected to be present to take control of the vehicle, and a third driving mode where a driver is not expected to be present to take control of the vehicle. The method includes while operating in the second driving mode, receiving, by one or more computing devices, a request to transition to the first driving mode; in response to the request, transitioning, by the one or more computing devices, to the first driving mode; and after transitioning to the first driving mode, preventing, by the one or more computing devices, a transition from the first driving mode to the second driving mode or the third driving mode until a predetermined duration has passed even when input is received at one or more of a steering wheel, brake pedal or accelerator during the predetermined period.

In one example, the request includes a user input at one of a steering control input, a deceleration control input, or an acceleration control input. In another example, the predetermined duration is a predetermined period of time. In this example, the predetermined period of time is at least 0.1 second. Alternatively, the predetermined duration is a predetermined number of message cycles. In addition, the predetermined duration is at least 10 message cycles. In another example, preventing a transition from the first driving mode to the second driving mode or the third driving mode includes determining valid engagement commands for the first driving mode are received for an entirety of the predetermined duration. In another example, preventing a transition from the first driving mode to the second driving mode or the third driving mode includes determining whether there is a missing engagement command for the first driving mode during the predetermined duration. In this example, preventing a transition from the first driving mode to the second driving mode or the third driving mode includes starting a timer for the predetermined duration, and wherein when it is determined that there is a missing engagement command for the first driving mode during the predetermined duration, restarting the timer. In another example, preventing a transition from the first driving mode to the second driving mode or the third driving mode includes determining whether there is an invalid message received during the predetermined duration. In this example, preventing a transition from the first driving mode to the second driving mode or the third driving mode includes starting a timer for the predetermined duration, and wherein when it is determined that there is an invalid message received during the predetermined duration, restarting the timer.

Another aspect of the disclosure provides a system for controlling transitions between driving modes of an autonomous vehicle. The vehicle includes a first driving mode that is a manual driving mode, a second driving mode that is an autonomous driving mode where a driver is expected to be present to take control of the vehicle, and a third driving mode where a driver is not expected to be present to take control of the vehicle. The system includes one or more computing devices configured to: while operating in the second driving mode, receive a request to transition to the first driving mode; in response to the request, transition to the first driving mode; and after transitioning to the first driving mode, prevent a transition from the first driving mode to the second driving mode or the third driving mode until a predetermined duration has passed even when input is received at one or more of a steering wheel, brake pedal or accelerator during the predetermined period.

In this example, the request includes a user input at one of a steering control input, a deceleration control input, or an acceleration control input. In another example, the predetermined duration is a predetermined period of time. In another example, the predetermined duration is a predetermined number of message cycles. In another example, the one or more computing devices are further configured to prevent a transition from the first driving mode to the second driving mode or the third driving mode by determining valid engagement commands for the first driving mode are received for an entirety of the predetermined duration. In another example, the one or more computing devices are further configured to prevent a transition from the first driving mode to the second driving mode or the third driving mode by determining whether there is a missing engagement command for the first driving mode during the predetermined duration. In this example, the one or more computing devices are further configured to prevent a transition from the first driving mode to the second driving mode or the third driving mode by starting a timer for the predetermined duration, and when it is determined that there is a missing engagement command for the first driving mode during the predetermined duration, to restart the timer. In another example, the one or more computing devices are further configured to prevent a transition from the first driving mode to the second driving mode or the third driving mode by determining whether there is an invalid message received during the predetermined duration. In another example, the one or more computing devices are further configured to prevent a transition from the first driving mode to the second driving mode or the third driving mode by starting a timer for the predetermined duration, and when it is determined that there is an invalid message received during the predetermined duration, to restart the timer.

### BRIEF DESCRIPTION OF THE DRAWINGS

FIG. 1 is a functional diagram of an example vehicle in accordance with an exemplary embodiment.

FIGS. 2A-2B are an example functional diagrams of systems in accordance with aspects of the disclosure.

FIG. 3 is an example external view of a vehicle in accordance with aspects of the disclosure.

FIG. 4 is a pictorial diagram of an example system in accordance with aspects of the disclosure.

FIG. 5 is a functional diagram of the system of FIG. 4 in accordance with aspects of the disclosure.

FIGS. 6-8 are example timing diagrams in accordance with aspects of the disclosure.

FIG. 9 is an example flow diagram in accordance with aspects of the disclosure.

### DETAILED DESCRIPTION

### Overview

Autonomous vehicles or vehicles having an autonomous driving mode may have many different modes of operation ranging from manual (where a driver controls braking, acceleration and steering) to fully autonomous (where a computer controls deceleration, acceleration and steering) and various modes there between. In such systems, a driver may switch between modes, for instance from autonomous to manual, by providing input at an input device, such as a steering wheel, brake pedal, accelerator pedal, buttons, etc. The vehicle's actuators may receive signals from these input devices may then transition control of deceleration, acceleration, and steering to the driver.

For instance, a first driving mode of the vehicle may be a manual mode, a driver is able to control the deceleration, acceleration, and steering of a vehicle at the input devices. In addition, the vehicle is configured such that commands from the autonomous driving control system to control the actuators of the vehicles (e.g. actuators of the steering, acceleration and deceleration systems) are given no priority. In other words, in the manual mode, commands from the autonomous driving control system are invalid or ignored. In this way, the driver is guaranteed that the autonomous driving control system will not interfere with operation of the vehicle.

A second driving mode of the vehicle may be a first autonomous mode, the autonomous driving control system may expect that a driver is presently in the vehicle and capable of controlling the vehicle in the manual driving mode. In other words, the computing devices are configured to readily allow transitions from the first autonomous mode to the manual mode. The vehicle is configured such that commands originating from the user inputs are given priority over commands from the autonomous driving control system. In this regard, the driver is able to readily take control by using any of the input devices of the vehicle. At the same time, driver inputs will be prioritized by actuators of the vehicle over those of the autonomous driving control system.

A third driving mode of the vehicle may include a second autonomous mode, the computing devices may expect that a driver is not presently in the vehicle and capable of controlling the vehicle in the manual driving mode. In this configuration, both the actuators of the vehicle and autonomous driving control system act to limit the impact of human inputs and transitions to the manual mode in order to guarantee the safety of passengers and the vehicle.

As a safety feature, when operating in the second driving mode, if a human input is detected, for example at the steering wheel or either of the brake or accelerator pedals, the actuators of the vehicle may automatically transition to the first driving mode. Once the transition to first driving mode is made, the autonomous driving control system should immediately transition to the first driving mode. However, if the autonomous driving control system fails to detect that the driver has taken control, the autonomous driving control system may continue to command the second driving mode and the actuators may switch back to the second driving mode in response to the autonomous driving control system command. In some instances, this can create a “loop” where a driver grabs the steering wheel or presses either of the pedals, the actuators transition to the first driving mode, the autonomous driving control system simply continues to command the second driving mode, and thereafter the actuators immediately transition back to the second driving mode. Each time the driver continues to grab the wheel or press on either of the pedals and the loop repeats.

In order to avoid this type of loop, the transition of the vehicle from the first driving mode to the second driving mode may include a timing requirement. The timing requirement may include that the actuators will not transition out of the first driving mode and into the second or third driving modes until the actuators have received a valid first driving mode engagement command for at least a predetermined duration. In this regard, if there is a missing or invalid message at any point during the entirety of the predetermined duration, the actuators would not be able to transition to the second or third driving modes. Examples of invalid messages may include an invalid alive counter, an invalid checksum, an invalid signal, etc. This may prevent the vehicle from transitioning out of the first driving mode too quickly while not limiting transitions to the first driving mode.

For instance, once the actuators transition to the first driving mode, a timer may be started. The timer may be used to track the predetermined duration. Prior to the timer running out, the actuators may not be able to transition to the second or third driving modes. If a valid message to engage the second or third driving mode is received during the predetermined period, the timer may be restarted.

The predetermined duration may be a predetermined period of time such as 0.1 seconds or more or less and/or a fixed number of message cycles such as 10 message cycles or more or less. These values may be selected based on a base transmit rate of the autonomous driving control system with a multiplier or offset. In this regard, the first predetermined duration may depend upon the system architecture.

In addition, the vehicles may be configured such that immediately after the autonomous driving control system is turned on, reset, powered up, etc. the vehicle is able to transition into the third driving mode without requiring human or external inputs. In this regard, before transitioning into the third driving mode, a driver need not press the brake pedal or take another physical action with respect to the vehicle. This may be a critical feature for the operation of a large fleet of vehicles. In other words, as the number of vehicles in the fleet increases, more drivers would be required to be physically present to manually engage the third driving mode. Thus, such additional drivers would not be required and the vehicles would be able to park and turn off in parking lots or in street parking not necessarily controlled by the service.

The features described herein may improve the safety of transitioning between different driving modes in a way that allows a driver to comfortably take control of a vehicle without the autonomous driving control systems of the vehicle incorrectly taking over if there is a fault.

### Example Systems

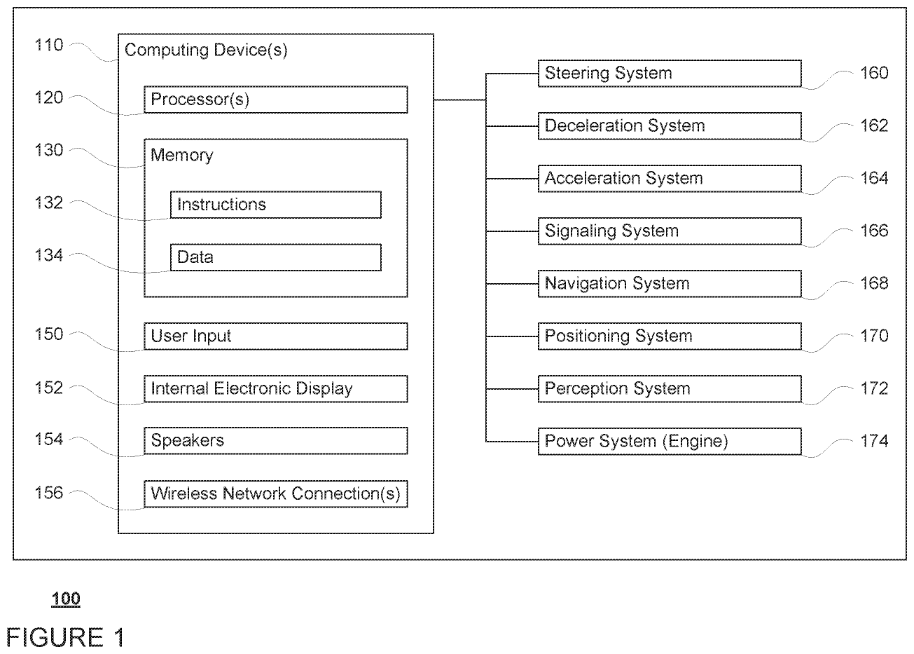

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, buses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 134 and data 132 that may be executed or otherwise used by the processor 120. The memory 130 may be of any type capable of storing information accessible by the processor, including a non-transitory computing device-readable or other machine-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processor 120 may be any conventional processors, such as commercially available CPUs or GPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing devices 110 may include all of the components normally used in connection with a computing device such as the processor and memory described above as well as a user input 150 (e.g., a mouse, keyboard, touch screen and/or microphone), various electronic displays (e.g., a monitor having a screen or any other electrical device that is operable to display information), and speakers 154 to provide information to a passenger of the vehicle 100 as needed. For example, electronic display 152 may be located within a cabin of vehicle 100 and may be used by computing devices 110 to provide information to passengers within the vehicle 100.

Computing devices 110 may also include one or more wireless network connections 156 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

The computing devices 110 may be a part of an autonomous driving control system for the vehicle and may be capable of communicating with various components of the vehicle in order to control the vehicle in an autonomous driving mode. For example, returning to FIG. 1, the computing devices 110 may be in communication with various systems of vehicle 100, such as steering system 160, deceleration system 162, acceleration system 164, routing system 166, planning system 168, positioning system 170, and perception system 172 in order to control the movement, speed, etc. of vehicle 100 in accordance with the instructions 134 of memory 130 in the autonomous driving mode.

As an example, the computing devices 110 may interact with deceleration system 162 and acceleration system 162 in order to control the speed of the vehicle. Similarly, steering system 160 may be used by computing devices 110 in order to control the direction of vehicle 100. For example, if vehicle 100 is configured for use on a road, such as a car or truck, the steering system may include components to control the angle of wheels to turn the vehicle. The computing devices 110 may also use the signaling system in order to signal the vehicle's intent to other drivers or vehicles, for example, by lighting turn signals or brake lights when needed.

Routing system 166 may be used by the computing devices 110 in order to generate a route to a destination. Planning system 168 may be used by computing device 110 in order to follow the route. In this regard, the planning system 168 and/or routing system 166 may store detailed map information, e.g., highly detailed maps identifying a road network including the shape and elevation of roadways, lane lines, intersections, crosswalks, speed limits, traffic signals, buildings, signs, real time traffic information, pullover spots, vegetation, or other such objects and information.

The routing system 166 may use the map information to determine a route from a current location (e.g. a location of a current node) to a destination. Routes may be generated using a cost-based analysis which attempts to select a route to the destination with the lowest cost. Costs may be assessed in any number of ways such as time to the destination, distance traveled (each edge may be associated with a cost to traverse that edge), types of maneuvers required, convenience to passengers or the vehicle, etc. Each route may include a list of a plurality of nodes and edges which the vehicle can use to reach the destination. Routes may be recomputed periodically as the vehicle travels to the destination.

Positioning system 170 may be used by computing devices 110 in order to determine the vehicle's relative or absolute position on a map or on the earth. For example, the position system 170 may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude, a location of a node or edge of the roadgraph as well as relative location information, such as location relative to other cars immediately around it which can often be determined with less noise that absolute geographical location.

The positioning system 170 may also include other devices in communication with the computing devices computing devices 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

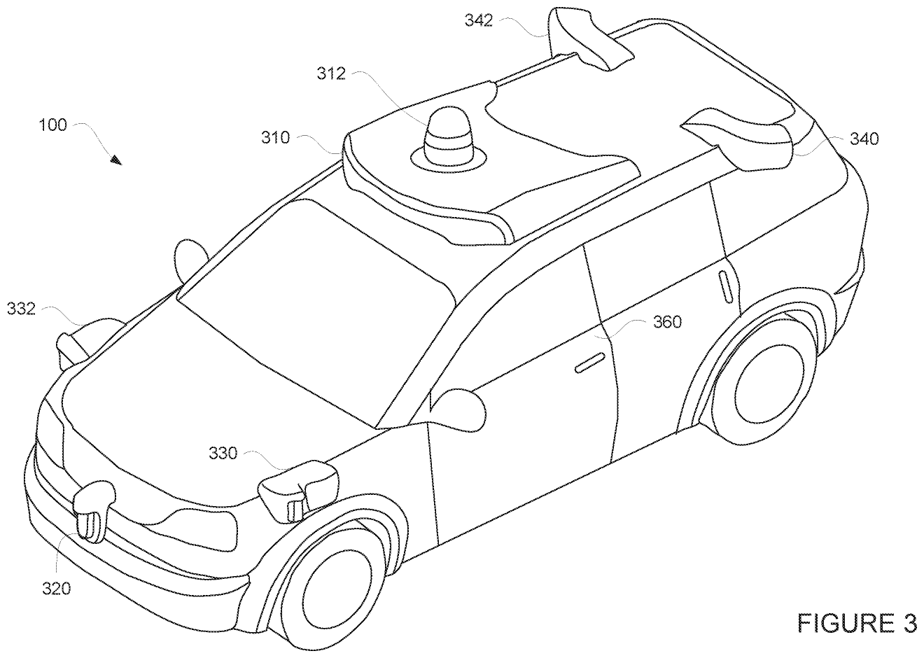

The perception system 172 also includes one or more components for detecting objects external to the vehicle such as other vehicles, obstacles in the roadway, traffic signals, signs, trees, etc. For example, the perception system 172 may include lasers, sonar, radar, cameras and/or any other detection devices that record data which may be processed by the computing devices of the computing devices 110. In the case where the vehicle is a passenger vehicle such as a minivan, the minivan may include a laser or other sensors mounted on the roof or other convenient location. For instance, FIG. 3 is an example external view of vehicle 100. In this example, roof-top housing 310 and dome housing 312 may include a LIDAR sensor as well as various cameras and radar units. In addition, housing 320 located at the front end of vehicle 100 and housings 330, 332 on the driver's and passenger's sides of the vehicle may each store a LIDAR sensor. For example, housing 330 is located in front of driver door 360. Vehicle 100 also includes housings 340, 342 for radar units and/or cameras also located on the roof of vehicle 100. Additional radar units and cameras (not shown) may be located at the front and rear ends of vehicle 100 and/or on other positions along the roof or roof-top housing 310.

The computing devices 110 may be capable of communicating with various components of the vehicle in order to control the movement of vehicle 100 according to primary vehicle control code of memory of the computing devices 110. For example, returning to FIG. 1, the computing devices 110 may include various computing devices in communication with various systems of vehicle 100, such as steering system 160, deceleration system 162, acceleration system 164, routing system 166, planning system 168, positioning system 170, perception system 172, and power system 178 (i.e. the vehicle's engine or motor) in order to control the movement, speed, etc. of vehicle 100 in accordance with the instructions 134 of memory 130.

The various systems of the vehicle may function using autonomous vehicle control software in order to determine how to and to control the vehicle. As an example, a perception system software module of the perception system 172 may use sensor data generated by one or more sensors of an autonomous vehicle, such as cameras, LIDAR sensors, radar units, sonar units, etc., to detect and identify objects and their characteristics. These characteristics may include location, type, heading, orientation, speed, acceleration, change in acceleration, size, shape, etc. In some instances, characteristics may be input into a behavior prediction system software module which uses various behavior models based on object type to output a predicted future behavior for a detected object. In other instances, the characteristics may be put into one or more detection system software modules, such as a traffic light detection system software module configured to detect the states of known traffic signals, construction zone detection system software module configured to detect construction zones from sensor data generated by the one or more sensors of the vehicle as well as an emergency vehicle detection system configured to detect emergency vehicles from sensor data generated by sensors of the vehicle. Each of these detection system software modules may uses various models to output a likelihood of a construction zone or an object being an emergency vehicle. Detected objects, predicted future behaviors, various likelihoods from detection system software modules, the map information identifying the vehicle's environment, position information from the positioning system 170 identifying the location and orientation of the vehicle, a destination location or node for the vehicle as well as feedback from various other systems of the vehicle may be input into a planning system software module of the planning system 168. The planning system 168 may use this input to generate trajectories for the vehicle to follow for some brief period of time into the future based on a route generated by a routing module of the routing system 166. In this regard, the trajectories may define the specific characteristics of acceleration, deceleration, speed, etc. to allow the vehicle to follow the route towards reaching a destination. A control system software module of the computing devices 110 may be configured to control movement of the vehicle, for instance by controlling braking, acceleration and steering of the vehicle, in order to follow a trajectory.

The computing devices 110 may control the vehicle in an autonomous driving mode by controlling various components. For instance, by way of example, the computing devices 110 may navigate the vehicle to a destination location completely autonomously using data from the detailed map information and planning system 168. The computing devices 110 may use the positioning system 170 to determine the vehicle's location and perception system 172 to detect and respond to objects when needed to reach the location safely. Again, in order to do so, computing device 110 and/or planning system 168 may generate trajectories and cause the vehicle to follow these trajectories, for instance, by causing the vehicle to accelerate (e.g., by supplying fuel or other energy to the engine or power system 174 by acceleration system 164), decelerate (e.g., by decreasing the fuel supplied to the engine or power system 174, changing gears, and/or by applying brakes by deceleration system 162), change direction (e.g., by turning the front or rear wheels of vehicle 100 by steering system 160), and signal such changes (e.g., by lighting turn signals). Thus, the acceleration system 164 and deceleration system 162 may be a part of a drivetrain that includes various components between an engine of the vehicle and the wheels of the vehicle. Again, by controlling these systems, computing devices 110 may also control the drivetrain of the vehicle in order to maneuver the vehicle autonomously.

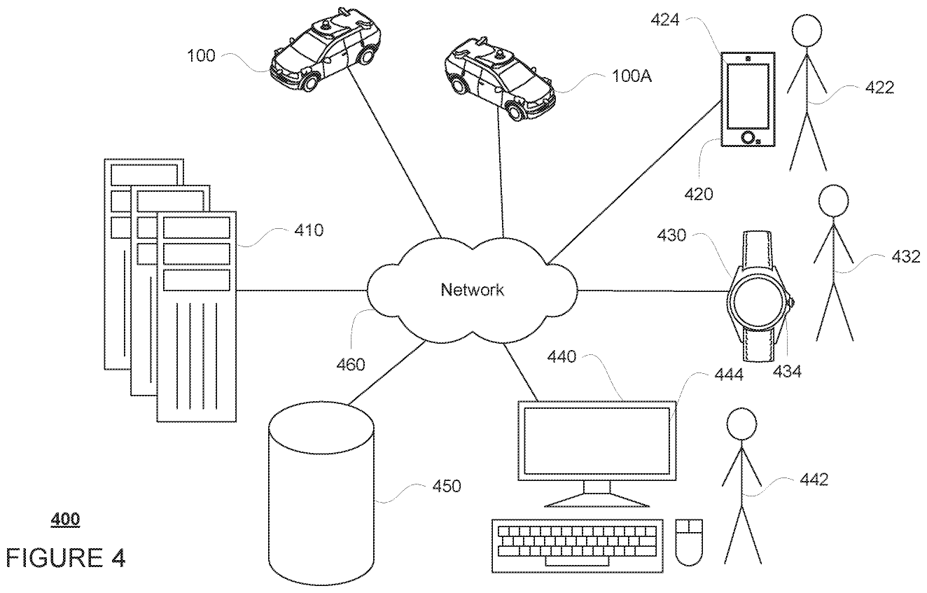

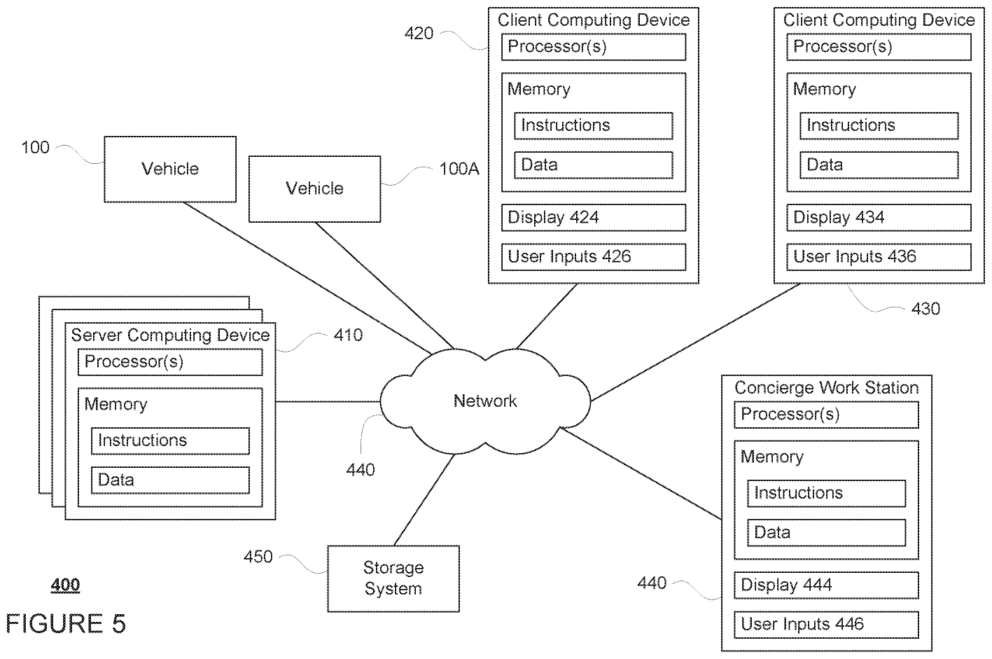

Computing device 110 of vehicle 100 may also receive or transfer information to and from other computing devices, such as those computing devices that are a part of the transportation service as well as other computing devices. FIGS. 4 and 5 are pictorial and functional diagrams, respectively, of an example system 400 that includes a plurality of computing devices 410, 420, 430, 440 and a storage system 450 connected via a network 460. System 400 also includes vehicle 100A and vehicle 100B, which may be configured the same as or similarly to vehicle 100. Although only a few vehicles and computing devices are depicted for simplicity, a typical system may include significantly more.

As shown in FIG. 5, each of computing devices 410, 420, 430, 440 may include one or more processors, memory, data and instructions. Such processors, memories, data and instructions may be configured similarly to one or more processors 120, memory 130, data 132, and instructions 134 of computing device 110.

The network 460, and intervening graph nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of vehicle 100 or a similar computing device of vehicle 100A or vehicle 100B as well as computing devices 420, 430, 440 via the network 460. For example, vehicles 100, 100A, 100B, may be a part of a fleet of vehicles that can be dispatched by server computing devices to various locations. In this regard, the server computing devices 410 may function as a fleet management system (hereafter fleet management system 410) which can be used to dispatch vehicles such as vehicles 100, 100A, 100B to different locations in order to pick up and drop off passengers. In addition, the fleet management system 410 may use network 460 to transmit and present information to a user, such as user 422, 432, 442 on a display, such as displays 424, 434, 444 of computing devices 420, 430, 440. In this regard, computing devices 420, 430, 440 may be considered client computing devices.

As shown in FIG. 5, each client computing device 420, 430, 440 may be a personal computing device intended for use by a user 422, 432, 442, and have all of the components normally used in connection with a personal computing device including a one or more processors (e.g., a central processing unit (CPU)), memory (e.g., RAM and internal hard drives) storing data and instructions, a display such as displays 424, 434, 444 (e.g., a monitor having a screen, a touch-screen, a projector, a television, or other device that is operable to display information), and user input devices 426, 436, 446 (e.g., a mouse, keyboard, touchscreen or microphone). The client computing devices may also include a camera for recording video streams, speakers, a network interface device, and all of the components used for connecting these elements to one another.

Although the client computing devices 420, 430, and 440 may each comprise a full-sized personal computing device, they may alternatively comprise mobile computing devices capable of wirelessly exchanging data with a server over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, shown as a wristwatch as shown in FIG. 4. As an example the user may input information using a small keyboard, a keypad, microphone, using visual signals with a camera, or a touch screen.

In some examples, client computing device 420 may be a mobile phone used by passenger of a vehicle. In other words, user 422 may represent a passenger. In addition, client communication device 430 may represent a smart watch for a passenger of a vehicle. In other words, user 432 may represent a passenger. The client communication device 440 may represent a workstation for an operations person, for example, a remote assistance operator or someone who may provide remote assistance to a vehicle and/or a passenger. In other words, user 442 may represent a remote assistance operator. Although only a few passengers and operations person are shown in FIGS. 4 and 5, any number of such, passengers and remote assistance operators (as well as their respective client computing devices) may be included in a typical system.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 4 and 5, and/or may be directly connected to or incorporated into any of the computing devices 110, 410, 420, 430, 440, etc.

Storage system 450 may store various types of information as described in more detail below. This information may be retrieved or otherwise accessed by a server computing device, such as one or more server computing devices of the fleet management system 410, in order to perform some or all of the features described herein.

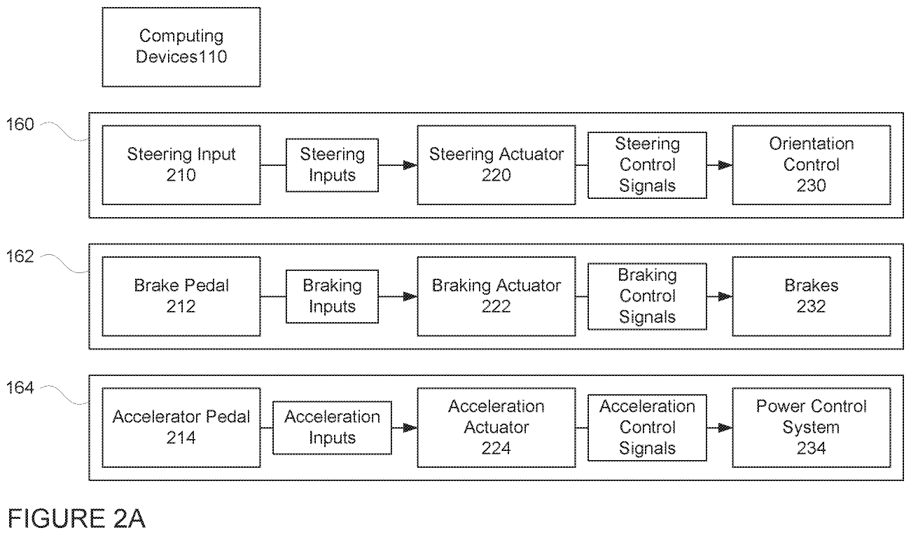

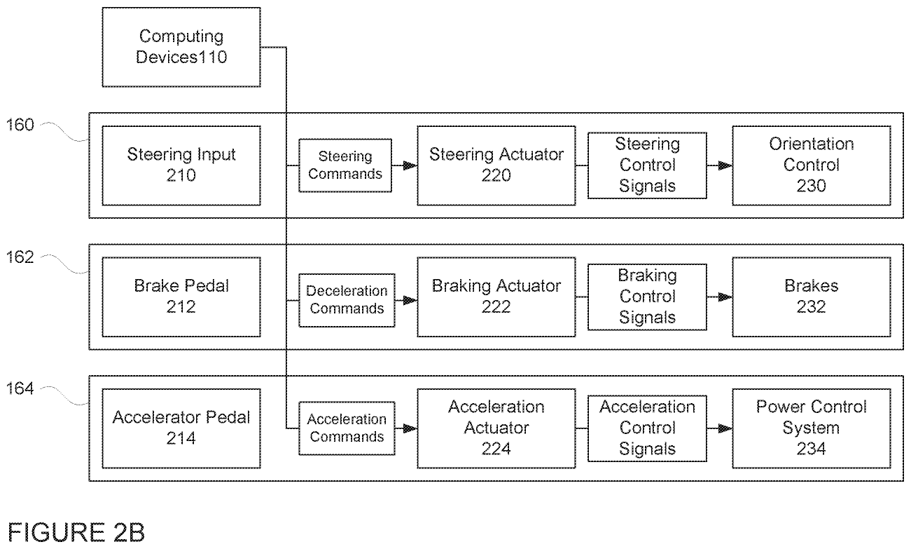

FIGS. 2A and 2B are a functional diagram of the steering, acceleration, and deceleration systems 160, 162, 164 and identifies example relationships between the user input devices which a driver uses to control the vehicle in the manual (or semiautonomous) driving modes, computing devices 110 which generates control commands to control the vehicle in the autonomous driving modes, and the actuators which send instructions to the hardware that control the orientation and speed of the vehicle. In this regard, each actuator may include one or more computing devices having one or more processors and memory which may be configured the same or similarly to computing devices 110, processors 120, and memory 130.

For instance, a steering input 210 (e.g. steering wheel or other device) of the vehicle can be used by the driver to cause the steering actuator 220 of the steering system 160 to control the orientation of the wheels using the orientation control hardware 230 which may include the vehicle's axles and other hardware that can change the orientation of the vehicle's wheels. For example, as shown in FIG. 2A, steering inputs to the steering input 210 are sent to the steering actuator 220 which converts those inputs into corresponding steering control signals which can be acted upon by the orientation control hardware 230. Depending upon the configuration of the vehicle, drive-by-wire or a mechanical connection, these steering inputs may be converted to electronic signals before being received by the steering actuator or may be received physically by a hardware connection to the steering actuator. Similarly, as shown in FIG. 2B, the computing devices 110 may send commands to the actuator 220 to cause the actuator 220 to send corresponding steering control signals to the orientation control hardware 230 to control the orientation of the wheels.

The brake pedal 212 can be used by the driver to cause the actuator 222 of the deceleration system 162 to control the position of the brakes 232. For example, as shown in FIG. 2A, inputs to the brake pedal 212 are sent to the braking actuator 222 which converts those inputs into braking control commands which can be acted upon by the brakes 232. Depending upon the configuration of the vehicle, drive-by-wire or a mechanical connection, these braking inputs may be converted to electronic signals before being received by the braking actuator or may be received physically by a hardware connection to the braking actuator. Similarly, as shown in FIG. 2B, the computing devices 110 may send commands to the actuator 220 to cause the braking actuator to send corresponding braking control commands to control the position of the brakes.

The accelerator pedal 214 can be used by the driver to cause the acceleration actuator 224 of the acceleration system 162 to control the amount of fuel or energy sent by a fuel or power control system 234 to the engine or motor which in turn, controls the speed of rotation of the vehicle's wheels. The power control system may thus control the amount of fuel (e.g. gasoline, diesel, etc.) or power (from one or more batteries) to the engine or motor of the power system 174. For example, as shown in FIG. 2A, inputs to the accelerator pedal 214 are sent to the acceleration actuator 224 which converts those inputs into acceleration control commands which can be acted upon by the power control system 234. Similarly, as shown in FIG. 2B, the computing devices 110 may send acceleration commands to the actuator 210 to cause the acceleration actuator to send acceleration control signals to the fuel or power control system 234 of the power system 174 in order to control the amount of fuel or energy sent to the engine or motor.

The memory 130 of computing device 110 and/or the memory of the actuators or one or more other computing devices may store configuration instructions to allow the vehicle 100 to operate in different modes including a first driving mode which is a manual driving mode as well as one or more autonomous driving modes. In the manual driving mode, a driver is able to control the deceleration, acceleration, and steering of a vehicle at the user inputs, such as the steering input 210, the brake pedal 212, and the accelerator pedal 214. In addition, vehicle 100 is configured via the configuration instructions such that commands from the computing devices 110 to control the actuators of the steering system 160, deceleration system 162, and acceleration system 164 are given no priority. In other words, in the manual driving mode, commands from the computing devices 110 are invalid or ignored by the steering actuator 220, braking actuator 222, and acceleration actuator 224. In this way, the driver is guaranteed that the autonomous driving control system will not interfere with operation of vehicle 100.

In a second driving mode, or a first autonomous driving mode, the computing devices 110 may expect that a driver is presently in vehicle 100 and capable of controlling the vehicle in the manual driving mode. In other words, the computing devices 110 are configured via the configuration instructions to readily allow transitions from the second driving mode to the first driving mode or rather, from first autonomous driving mode to the manual driving mode. Vehicle 100 is also configured such that commands originating from the user inputs, such as the steering input 210, the brake pedal 212, and the accelerator pedal 214 are given priority over commands from the computing devices 110. In this regard, the driver is able to readily take control by using any of the steering input 210, the brake pedal 212, and the accelerator pedal 214 of vehicle 100. At the same time, the driver is guaranteed by both the computing devices 110 and the steering, braking and acceleration actuators that driver inputs will be prioritized over those of the computing devices 110.

The first autonomous driving mode may also have a plurality of different sub-modes or configurations which allows for different levels of autonomy in different environments. For instance, the first autonomous driving mode may have a first configuration that allows for a fully-autonomous driving mode in specific areas of a pre-mapped environment, but semi-autonomous driving modes (e.g. where a driver controls speed and/or steering) everywhere else. A second configuration may allow a driver to adjust to increase the sensitivity of vehicle 100 to transitions to manual driving mode, for instance, where a driver prefers to more easily change vehicle 100 from the first autonomous driving mode to a semi-autonomous or the manual driving mode.

The first autonomous driving mode may also include a third configuration with additional modifications to allow for safe testing of vehicle 100 when a test driver is present. In order to have a redundant and more reliable means of guaranteeing test driver takeover ability, the transition between the first driverless mode and manual driving mode may be implemented in two different places: the computing devices 110 and at each actuator. The actuator software may be considered well vetted and fixed due to extensive testing and may not change very often. However, the software of the computing devices 110 may be changed and tested regularly. Because the actuators may transition to the manual driving mode independently of the computing devices 110, commands from the computing devices 110 which are improper (i.e. those which continue even though there is a transition to the manual driving mode) are invalid and ignored. This transition may occur, for example, by having a driver (or test driver) take control of one or more of steering, braking, or acceleration. This allows for the safe and effective testing of new or updated software at the computing devices 110.

In a third driving mode, or a second autonomous driving mode, the computing devices 110 may expect that a driver is not presently in vehicle 100 and capable of controlling vehicle 100 in the manual driving mode. In this configuration, both the actuators and computing devices 110 are configured via the configuration instruction to limit the impact of human inputs and transitions to the first driving more or the manual driving mode in order to guarantee the safety of passengers and vehicle 100. In other words, the first autonomous driving mode may be “easier” to enter than the second autonomous driving mode in order to limit use of the second driving mode to situations in which there is no driver capable of controlling vehicle 100 present.

As with the first autonomous driving mode, the second autonomous driving mode may include a plurality of different sub-modes or configurations. As an example, a first configuration may be a fully autonomous “driverless transportation service” mode which can be used to allow vehicle 100 to provide transportation services to passengers or users of the transportation service. This configuration may prevent vehicle 100 from starting a trip if the vehicle does not meet certain conditions, such as if the vehicle is dirty, a door is open, passengers are not sitting in seats and/or do not have seat belt bucked, the vehicle is overloaded (there is too much weight in the vehicle's seats and/or cargo compartments), etc. This configuration may also utilize a partition to prevent passengers from reaching manual controls (steering wheel, brake pedal, acceleration pedal, etc.).

This first configuration may also allow vehicle 100 to accept instruction from a dispatching server such as the server computing devices 410. For instance, when in the first configuration of the second autonomous driving mode, vehicles may be dispatched and/or staged by the server computing devices 410 to locations where a vehicle can safely wait to be assigned a trip. This may include sending a vehicle to a specific location, for instance, waiting at a specific shaded area near a mall, or sending a vehicle to a specific area, for instance, a specific square mile or more or less to drive around and wait for an assignment. Similarly, vehicles may be limited to trips in certain areas as discussed above using, for instance, the second configuration of the second driving mode or by sending vehicle 100 to that area and using geo-fencing to limit movements of the vehicle to within certain areas. This may allow the dispatching servers to confirm that vehicles are sent only where needed, and thereby allow more efficient staging and use of a fleet of vehicles.

A second configuration may be similar to the first configuration, but with some limitations determined based on the current status of vehicle 100. For instance, vehicle 100 may be prevented from entering specific regions, such as school zones, highways, etc., based on the vehicle's computing device's current software version, state of the vehicle's sensors (whether all are operating within normal parameters and/or whether the sensors were calibrated within some predetermined number of miles or period of time, such as 100 miles or more or less or 24 hours), etc. In this regard, if vehicle 100's sensors have not been calibrated at a depot within the last 100 miles or last 24 hours, the vehicle may not be able to drive on highways or in school zones. For instance, if certain sensors, such as radar or cameras, are not recently calibrated, the vehicle may need to avoid unprotected left turns or certain intersections having traffic lights at certain relative positions.

The second autonomous driving mode may also include a third configuration for testing vehicle 100. In this example, the computing devices may control vehicle 100 according to the configuration instructions as if the vehicle were operating in the first configuration. However, a test driver, rather than taking control of steering, acceleration, or deceleration, may use an “emergency stopping” button to immediately stop vehicle 100 in the event of a problem. In this regard, vehicle 100 may apply all braking power available immediately to stop the vehicle as quickly as possible. Generally, because such immediate stopping is not appropriate for when vehicle 100 is providing transportation services, the emergency stopping button may not be available (i.e. may be removable) when operating in the first configuration. In such cases, vehicle 100 may be stopped by a passenger using a pull over request via the passenger's client computing device or a pull over button of the vehicle.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

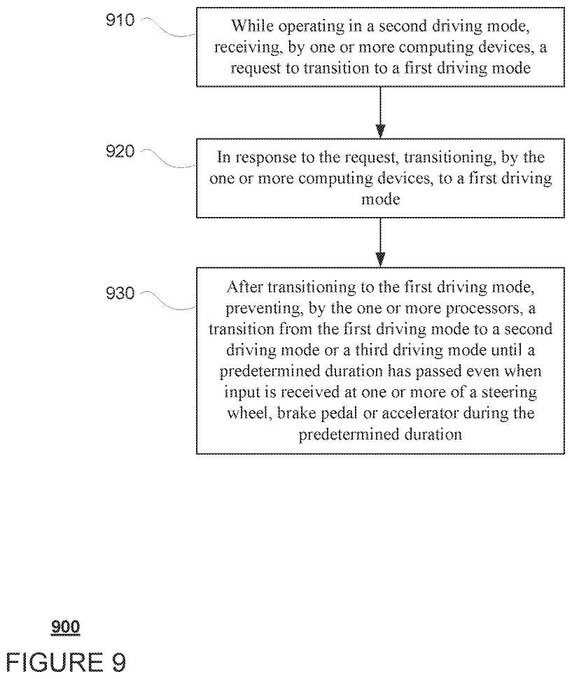

FIG. 9 provides an example flow diagram 900 for controlling transitions between driving modes of an autonomous vehicle, the vehicle having a first driving mode that is a manual driving mode, a second driving mode that is an autonomous driving mode where a driver is expected to be present to take control of the vehicle, and a third driving mode where a driver is not expected to be present to take control of the vehicle. The diagram may represent steps taken by various features of the vehicle, such as the steering actuator 220, the braking actuator 222 and the acceleration actuator 224, the one or more computing devices 110, or another computing device of the vehicle, etc. For instance, at block 910, while the vehicle is being operated in the second driving mode, a request to transition to the first driving mode is received. This request may take the form of driver (or other human) input at one or more user inputs of the vehicle such as a steering input 210, a brake pedal 212, or an accelerator pedal 214.

At block 920, in response to the request, the vehicle is transitioned to the first driving mode. Again, this first driving mode is a manual driving mode where the actuators accept commands from the input devices, such as the steering actuator 220, the braking actuator 222 or the acceleration actuator 224. Thus, the transitioning causes the actuators to act upon inputs from these user inputs. As noted above, as a safety feature, when operating in the second driving mode, if a human input is detected, for example at the steering wheel or either of the brake or accelerator pedals, the actuators, such as the steering actuator 220, the braking actuator 222 or the acceleration actuator 224, may automatically transition to the first driving mode. Once the transition to first driving mode is made, the autonomous driving control system should immediately transition to the first driving mode or rather, should stop sending steering, braking and acceleration commands to the actuators. In this regard, one or more computing devices, such as the computing devices 110 of the autonomous driving control system may monitor reported driving modes of the actuators (e.g. from signs received from the actuators) and/or the state of the driver inputs (e.g. steering input 210, brake pedal 212, and/or accelerator pedal 214.

However, if the autonomous driving control system fails to detect that the driver has taken control (e.g. at the steering and/or pedals) the autonomous driving control system may continue to command the second driving mode and the actuators may switch back to the second driving mode in response to the autonomous driving control system commands. In some instances, this can create a “loop” where a driver grabs the steering wheel or presses either of the pedals, the actuators transition to the first driving mode, the autonomous driving control system simply continues to command the second driving mode, and thereafter the actuators immediately transition back to the second driving mode. Each time the driver continues to manipulate or simply grab the steering input 210 or press on either of the brake pedal 212 or accelerator pedal 214 and the loop repeats.

In order to avoid this type of loop, the transition of the vehicle from the first driving mode to the second driving mode may include a timing requirement. In other words, as shown in block 930, after transitioning to the first driving mode, a transition from the first driving mode to the second driving mode or the third driving mode is prevented until a predetermined duration has passed. The timing requirement may include that the actuators, such as the steering actuator 220, the braking actuator 222 or the acceleration actuator 224, will not transition out of the first driving mode and into the second or third driving modes until one or more of the actuators have received a valid first driving mode engagement command (or simply a command to operate manually) or rather a manual mode engagement command. For example, the autonomous control driving system may send a unique engagement command or simply a command to each actuator to engage the first, second, or third driving mode. If the actuators detect human input and change to the first diving mode (or the manual driving mode), the actuators will not transition into the to the second or third driving modes (or an autonomous driving mode) until the actuators have received a valid engagement command (or simply a command) for the first driving mode for at least a predetermined duration. In this way, the vehicle will be operated in the manual driving mode for at least the predetermined duration before being able to transition into an autonomous driving mode.

In this regard, if there is a missing or invalid message during the predetermined duration, the actuators would not be able to transition to the second or third driving modes. Examples of invalid messages may include an invalid alive counter, an invalid checksum, an invalid signal, etc. This may prevent the vehicle from transitioning out of the first driving mode too quickly while not limiting transitions to the first driving mode (e.g. does not affect the driver's ability to take control of the vehicle in an emergency).

For instance, once the actuators transition to the first driving mode, a timer may be started. The timer may be used to track the predetermined duration. Prior to the timer running out (i.e. by counting down or up for the predetermined period), the actuators may not be able to transition to the second or third driving modes. If a valid message to engage the second or third driving mode is received during the predetermined period, the timer may be restarted.

The predetermined duration may be a predetermined period of time such as 0.1 seconds or more or less and/or a fixed number of message cycles such as 10 message cycles or more or less. These values may be selected based on a base transmit rate of the autonomous driving control system with a multiplier or offset. In this regard, the first predetermined duration may depend upon the system architecture.

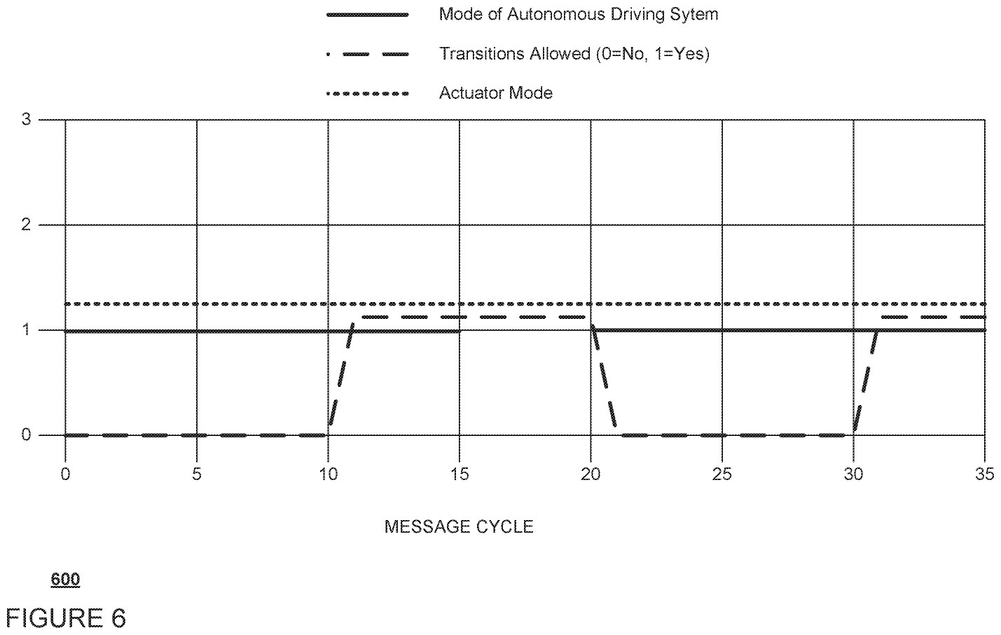

FIGS. 6-8 provide example timing diagrams or graphs which demonstrate various examples of the above features over the course of 35 message cycles. Each example provides the mode of the autonomous driving system, identifies whether or not transitions to the autonomous driving mode are allowed, and also provides the mode of the actuators, such as the steering actuator 220, the braking actuator 222 or the acceleration actuator 224. In these examples, the aforementioned predetermined period is set to 10 message cycles.

A line representing the mode of the autonomous driving system having a value of 1 represents that the autonomous driving system is not actively sending commands to the actuators, that is the computing devices 110 are not sending commands to the actuators because the autonomous driving system understands the vehicle 100 to be in the first driving mode or the manual driving mode. A line representing the mode of the autonomous driving system having a value of 2 represents that the autonomous driving system is in either the first or second autonomous driving mode, that is the computing devices 110 are sending commands to the actuators.

Transitions to the autonomous driving modes, such as the second or third driving modes, are allowed for when a line representative of whether transitions are allowed for a value of 1 (depicted slightly above 1 in the graph in order to differentiate from the other lines in the graph) and not allowed for a value of 0.

A line representing the actuator mode having a value of 2 (depicted slightly above 2 in the graph in order to differentiate from the other lines in the graph) represents that the actuators are accepting commands from the computing devices 110 in either the second or third driving modes or the first autonomous driving mode or the second autonomous driving mode. Similarly, a line representing the actuator mode having a value of 1 represents that the actuators are in the first driving mode or the manual driving mode and are accepting commands from input devices, such as the steering input 210, the brake pedal 212, and accelerator pedal 214, and ignoring commands from the computing devices 110.

Turning to example 600 of FIG. 6, at the “0” message cycle, the actuators have just transitioned to the first driving mode or the manual driving mode, and thus, the value of the actuator mode is 1. As such, the aforementioned timer may be started. For the predetermined period, here 10 message cycles, transitions to the second or third driving mode are not allowed until the timer has run out. Thus, the value of the transitions allowed line is at 0. After 10 message cycles, transitions are allowed, so the value of the transitions allowed line goes to 1. After 15 message cycles, there is a “gap” representative of an invalid mode command, here a missing command. After 5 missed messages, the value of the transitions allowed line goes back to 0, and communication then resumes. Once communications are resumed, the aforementioned timer may be started. For the predetermined period, here 10 message cycles, transitions to the second or third driving mode are not allowed until the timer has run out. Starting at the “20” message cycle, for the next 10 message cycles, valid commands are received. At this point, the timer runs out, and at the “30” message cycle, transitions are allowed (though not made as the value of the actuator mode line remains 1) for the next 5 message cycles.

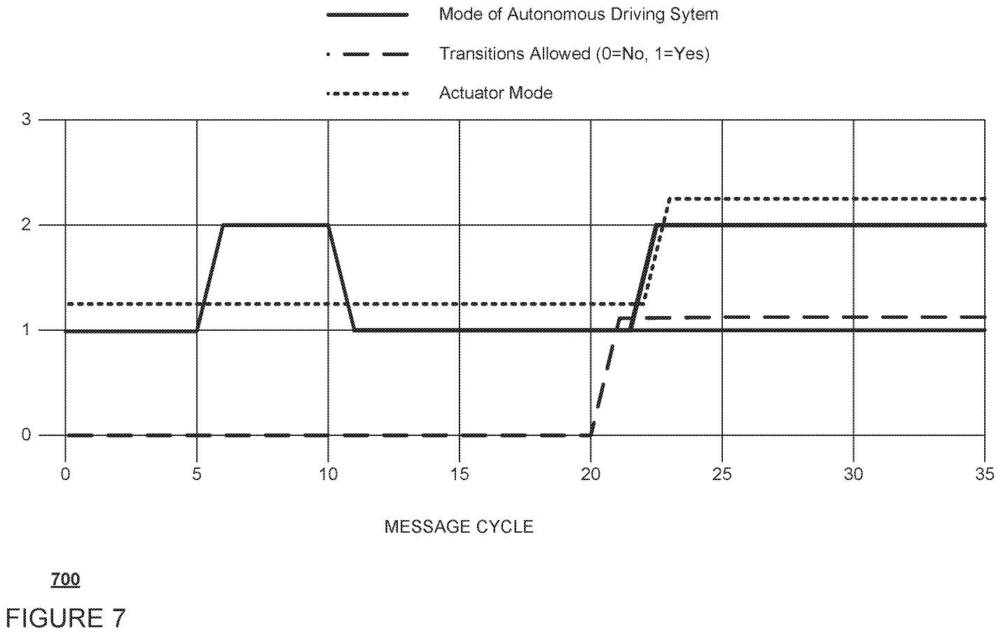

Turning to example 700 of FIG. 7, at the “0” message cycle, the actuators are transitioned into the first driving mode or the manual driving mode and thus, the value of the actuator mode line is 1. After 5 message cycles, the value of the mode of the autonomous driving system goes to 2. At this point, the autonomous driving system activates, for example in error, and the computing devices 110 begin sending commands to the actuators. As such, the aforementioned timer may be started. Until the predetermined period, here 10 message cycles, has passed or rather, the timer has run out, transitions to the second or third driving mode are not allowed. Thus, the value of the transitions allowed line is 0, the actuators remain in the first driving mode or the manual driving mode (the value of the actuator mode remain at 1), and commands from the computing devices 110 are ignored by the actuators.

In this example, the computing devices 110 stop sending such commands after 10 message cycles, and the timer is restarted. After another 10 message cycles or rather at 20 message cycles, the predetermined period, here 10 message cycles, has passed and transitions are allowed. Thus the value of the transitions allowed line goes to 1. At that point or immediately after, the value of the mode of the autonomous driving system goes to 2. As a result, the autonomous driving system activates, for example because the driver has requested such a transition, and the computing devices 110 begin sending commands to the actuators. As a result, because transitions are allowed, the actuators transition to the second or third driving mode or the first or second autonomous driving mode and remain in this mode for the remainder of the 35 message cycles.

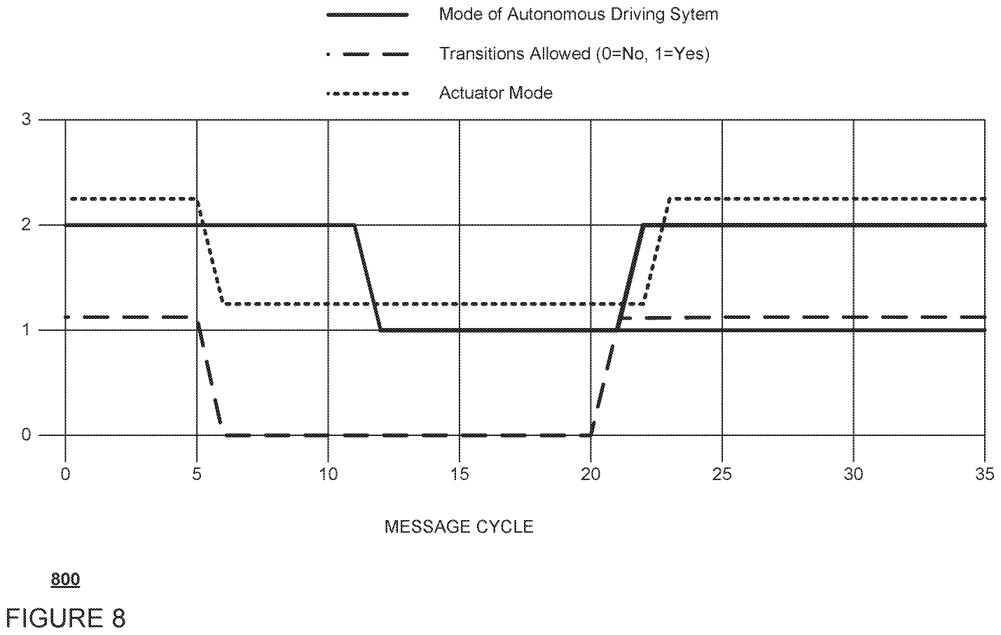

Turning to example 800 of FIG. 8, at the “0” message cycle, the actuators are in the second or third driving mode and thus, the value of the actuator mode line is 2. In addition, the autonomous driving system is active, so the computing devices 110 are sending commands to the actuators, and the value of the mode of the autonomous driving system is 2. At this point, transitions are allowed as the transitions allowed line is at 1. After 5 message cycles, the vehicle transitions to the first driving mode or the manual driving mode. As such, the value of the actuator mode line goes to 1. At this point, the autonomous driving system activates, for example in error, remains in the second or third driving mode or the first or second autonomous driving modes. As such, the computing devices 110 continue to send commands to the actuators. However, because the predetermined period, here 10 message cycles, has not passed transitions to the second or third driving mode are not allowed. Thus, the value of the transitions allowed line is 0, the actuators remain in the first driving mode or the manual driving mode (the value of the actuator mode remain at 1), and commands from the computing devices 110 are ignored by the actuators.

The computing devices 110 stop sending such commands after 11 message cycles, and the timer is restarted. After another 10 message cycles or rather at 21 message cycles, the predetermined period, here 10 message cycles, has passed and transitions are allowed. Thus the value of the transitions allowed line goes to 1. At that point or immediately after, the autonomous driving system activates, for example because the driver has requested such a transition, and the computing devices 110 begin sending commands to the actuators. As such, the value of the mode of the autonomous driving system goes to 2. As a result, because transitions are allowed, the actuators transition to the second or third driving mode or the first or second autonomous driving mode and remain in this mode for the remainder of the 35 message cycles.

In addition, the vehicles may be configured such that immediately after the autonomous driving control system is turned on, reset, powered up, etc. the vehicle 100 is able to transition into the third driving mode without requiring human or external inputs. In this regard, before transitioning into the third driving mode, a driver need not press the brake pedal or take another physical action with respect to the vehicle. This may be a critical feature for the operation of a large fleet of vehicles. In other words, as the number of vehicles in the fleet increases, more drivers would be required to be physically present to manually engage the third driving mode. Thus, such additional drivers would not be required and the vehicles would be able to park and turn off in parking lots or in street parking not necessarily controlled by the service.

The features described herein may improve the safety of transitioning between different driving modes in a way that allows a driver to comfortably take control of a vehicle without the autonomous driving control system of the vehicle incorrectly taking over if there is a fault.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of controlling transitions between driving modes of an autonomous vehicle, the vehicle having a first driving mode that is a manual driving mode, a second driving mode that is an autonomous driving mode where a driver is expected to be present to take control of the vehicle, and a third driving mode where a driver is not expected to be present to take control of the vehicle, the method comprising:
while operating in the second driving mode, receiving, by one or more computing devices, a request to transition to the first driving mode;
in response to the request, transitioning, by the one or more computing devices, to the first driving mode; and
after transitioning to the first driving mode, preventing, by the one or more computing devices, a transition from the first driving mode to the second driving mode or the third driving mode until a predetermined duration has passed even when input is received at one or more of a steering wheel, brake pedal, or accelerator during the predetermined duration.

2. The method of claim 1, wherein the request includes a user input at one of a steering control input, a deceleration control input, or an acceleration control input.

3. The method of claim 1, wherein the predetermined duration is a predetermined period of time.

4. The method of claim 3, wherein the predetermined period of time is at least 0.1 second.

5. The method of claim 1, wherein the predetermined duration is a predetermined number of message cycles.

6. The method of claim 5, wherein the predetermined duration is at least 10 message cycles.

7. The method of claim 1, wherein preventing a transition from the first driving mode to the second driving mode or the third driving mode includes determining valid engagement commands for the first driving mode are received for an entirety of the predetermined duration.

8. The method of claim 1, wherein preventing a transition from the first driving mode to the second driving mode or the third driving mode includes determining whether there is a missing engagement command for the first driving mode during the predetermined duration.

9. The method of claim 8, wherein preventing a transition from the first driving mode to the second driving mode or the third driving mode includes starting a timer for the predetermined duration, and wherein when it is determined that there is a missing engagement command for the first driving mode during the predetermined duration, restarting the timer.

10. The method of claim 1, wherein preventing a transition from the first driving mode to the second driving mode or the third driving mode includes determining whether there is an invalid message received during the predetermined duration.

11. The method of claim 10, wherein preventing a transition from the first driving mode to the second driving mode or the third driving mode includes starting a timer for the predetermined duration, and wherein when it is determined that there is an invalid message received during the predetermined duration, restarting the timer.

12. A system for controlling transitions between driving modes of an autonomous vehicle, the vehicle having a first driving mode that is a manual driving mode, a second driving mode that is an autonomous driving mode where a driver is expected to be present to take control of the vehicle, and a third driving mode where a driver is not expected to be present to take control of the vehicle, the system comprising one or more computing devices configured to:
while operating in the second driving mode, receive a request to transition to the first driving mode;
in response to the request, transition to the first driving mode; and
after transitioning to the first driving mode, prevent a transition from the first driving mode to the second driving mode or the third driving mode until a predetermined duration has passed even when input is received at one or more of a steering wheel, brake pedal, or accelerator during the predetermined duration.

13. The system of claim 12, wherein the request includes a user input at one of a steering control input, a deceleration control input, or an acceleration control input.

14. The system of claim 12, wherein the predetermined duration is a predetermined period of time.

15. The system of claim 12, wherein the predetermined duration is a predetermined number of message cycles.

16. The system of claim 12, wherein the one or more computing devices are further configured to prevent a transition from the first driving mode to the second driving mode or the third driving mode by determining valid engagement commands for the first driving mode are received for an entirety of the predetermined duration.

17. The system of claim 12, wherein the one or more computing devices are further configured to prevent a transition from the first driving mode to the second driving mode or the third driving mode by determining whether there is a missing engagement command for the first driving mode during the predetermined duration.

18. The system of claim 17, wherein the one or more computing devices are further configured to prevent a transition from the first driving mode to the second driving mode or the third driving mode by starting a timer for the predetermined duration, and when it is determined that there is a missing engagement command for the first driving mode during the predetermined duration, to restart the timer.

19. The system of claim 12, wherein the one or more computing devices are further configured to prevent a transition from the first driving mode to the second driving mode or the third driving mode by determining whether there is an invalid message received during the predetermined duration.

20. The system of claim 19, wherein the one or more computing devices are further configured to prevent a transition from the first driving mode to the second driving mode or the third driving mode by starting a timer for the predetermined duration, and when it is determined that there is an invalid message received during the predetermined duration, to restart the timer.
